(19) United States
(12) Patent Application Publication
(10) Pub. No.: US 2004/0150636 A1
(43) Pub. Date: Aug. 5, 2004

(54) Panel driver of liquid crystal display LCD device

(76) Inventor: Jeung-Hie Choi, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/748,532

(22) Filed: Dec. 29, 2003

(30) Foreign Application Priority Data
Feb. 4, 2003 (KR) 2003-6708

(51) Int. Cl. G09G 5/00

(52) U.S. Cl. 345/211

(57) ABSTRACT

A panel driver of a liquid crystal display device using a super twisted nematic STN mode (hereinafter, referred as a STN LCD device). The panel driver provides an efficient structure of the STN LCD device for large integration. A panel driver for driving a liquid crystal display device using a super twisted nematic STN mode includes at least one first unit for receiving a plurality of source voltages and supplying a selected source voltage among a plurality of driving power lines; and at least one second unit connected to the plurality of driving power lines for delivering the selected source voltage to a line.

### FIELD OF INVENTION

The present invention relates to a flat panel display; and, more particularly, to a panel driver for a liquid crystal display (LCD) device using a super twisted nematic (STN) mode.

### DESCRIPTION OF THE PRIOR ART

A liquid crystal display (LCD) device using a super twisted nematic (STN) mode (hereinafter, referred as a STN LCD device) is a kind of a flat display device which may show characters and figures on its screen. The STN LCD panel screen is generally used in a display device which has a basic function of presenting simple characters and figures like a display device used in a calculator and a mobile telephone. In the STN LCD panel screen, the nematic is used as a liquid crystalline.

In the STN LCD device, characters and figures are shown by black and white contrast on its screen, e.g., a black character on a white background or a white character on a black background.

FIG. 1 is a schematic circuit diagram showing structure of a cell array in the STN LCD device.

As shown, a plurality of unit cells C_{LC} is arranged in a matrix structure. Each unit cells C_{LC} is coupled to each common line, e.g., COM0, COM1 and COM2, and each segment line, e.g., SEG0, SEG1 and SEG2. Namely, in the unit cell C_{LC}, the liquid crystalline, i.e., nematic, is filled between two lines, i.e., the common line and the segment line. The liquid crystalline has a directional property for representing characters and figures if an electric field is formed between the common line and the segment line by supplying a driving voltage into each line, i.e., the common line and the segment line.

FIG. 2 is a schematic circuit diagram describing a panel driver of a conventional STN LCD device.

As shown, the STN LCD device includes a power supply block 110, a common line block 120 and a segment line block 130. The power supply block 110 has a plurality of source followers for delivering a plurality of source voltages, e.g., V0, V1, V2, V3 and V4 to the common line block 120 and the segment line block 130. The common line block 120 and the segment line block 130 respectively have a plurality of unit drivers.

The first segment unit driver 125 included in the segment line block 120 has four MOS transistors, i.e., two PMOS transistors and two NMOS transistors. A first PMOS transistor is coupled between a first segment line SEG0 and a first segment driving power line at which a first source voltage V0 is supplied. The gate of the first PMOS transistor is coupled to a first driving voltage control signal S01. Next, a second PMOS transistor is coupled between a first segment line SEG0 and a second segment driving power line at which a second source voltage V2 is supplied. The gate of the second PMOS transistor is coupled to a second driving voltage control signal S02. Next, a first NMOS transistor is coupled between a first segment line SEG0 and a third segment driving power line at which a third source voltage V3 is supplied. The gate of the first NMOS transistor is coupled to a third driving voltage control signal S03. Lastly, a second NMOS transistor is coupled between a first segment line SEG0 and a fourth source voltage VSS. The gate of the second NMOS transistor is coupled to a fourth driving voltage control signal S04.

Furthermore, other unit drivers in the segment line block 120 have the same structure as the first segment unit driver 125. Namely, other segment unit drivers have four MOS transistors which are coupled to the first to third segment driving power lines or the fourth source voltage VSS. However, each segment unit driver is controlled by each different first to fourth driving voltage control signals.

In addition, the first common unit driver 135 included in the common line block 130 has four MOS transistors, i.e., two PMOS transistors and two NMOS transistors. A third PMOS transistor is coupled between a first common line COM0 and a first common driving power line at which the first source voltage V0 is supplied. The gate of the third PMOS transistor is coupled to a fifth driving voltage control signal C01. Next, a fourth PMOS transistor is coupled between a first common line COM0 and a second common driving power line at which a fifth source voltage V1 is supplied. The gate of the second PMOS transistor is coupled to a sixth driving voltage control signal C02. Next, a third NMOS transistor is coupled between a first common line COM0 and a third common driving power line at which a fifth source voltage V4 is supplied. The gate of the third NMOS transistor is coupled to a seventh driving voltage control signal C03. Lastly, a fourth NMOS transistor is coupled between a first common line COM0 and the fourth source voltage VSS. The gate of the second NMOS transistor is coupled to an eighth driving voltage control signal C04.

Furthermore, other common unit drivers in the common line block 130 have the same structure as the first common unit driver I35. Namely, other common unit drivers have four MOS transistors which are coupled to the first to third common driving power lines or the fourth source voltage VSS. However, each common unit driver is controlled by each different fifth to eighth driving voltage control signals.

The STN LCD device typically employs six source voltage levels V0, V1, V2, V3, V4 and VSS. Herein, V0 is the highest source voltage level and VSS is the lowest source voltage level. The segment line block 120 uses V0, V2, V3 and VSS and the common line block 130 uses V0, V1, V4 and VSS.

FIG. 3A is a pixel layout depicting a plurality of pixels which are arranged in a matrix structure. FIG. 3B is a waveform showing the pulses supplied at each line, e.g., COM0, COM1, SEG0 and SEG1, of the conventional STN LCD device. As shown in FIG. 3A, each pixel is coupled to one common line and one segment line, e.g., COM0 and SEG0. A plurality of activated pixels may represent a character or a figure. A mark ‘_’ means the activated pixel during first and second frames in FIG. 3B.

Herein, referring to FIGS. 3A and 3B, there is described how to control each line for displaying any character or figure. As described above, the common line may be supplied with V0, V1, V4 and VSS. In a first frame, a first common line COM0 is supplied with the VSS and others are supplied with V1. Namely, the first common line COM0 is selected. At the same time, a first segment SEG0 is supplied with V0 and a second segment SEG1 is supplied with V2. As a result, a first pixel coupled to the first common line COM0 and the first segment line SEG0 is activated; and a second pixel coupled to the first common line COM0 and the second segment line SEG1 is inactivated. If not shown, other segment lines SEG2 to SEGm are supplied with V0 or V2. Herein, m is a positive integer and means the number of segment lines in the panel. Then, pixels coupled to the first common line COM0 and segment lines supplied with V0 are activated.

Thereafter, a second common line COM1 supplied with VSS is selected. At the same time, the first segment line SEG0 is supplied with V2; and the second segment line SEG1 is supplied with V0. As a result, a third pixel coupled to the second common line COM1 and the first segment line SEG0 is inactivated and a fourth pixel coupled to the second common line COM1 and the second segment line SEG1 is activated. If not shown, other segment lines SEG2 to SEGm are supplied with V0 or V2. Then, pixels coupled to the second common line COM1 and segment lines supplied with V0 are activated.

Likewise, other common lines COM1 to COMn can be selected, i.e., supplied by two source voltage among four source voltages V0, V1, V4 and VSS. Herein, n is a positive integer and means the number of common lines.

Next, in the second frame, the source voltage for selecting the common line and the segment line is changed because of the characteristics of liquid crystal. As shown, in the second frame, the common line supplied with V0 is sequentially selected. Also, in response to the source voltage of the common line, the source voltage supplied to the segment line is changed. Herein, pixels coupled to the segment line supplied with VSS are activated.

In the conventional STN LCD device, each segment line driver and each common line driver is composed of four MOS transistors for receiving one among each four source voltage levels. Thus, if the number of segment and common lines is increased, the number of panel driver is also increased; and, therefore, high integration of the driver circuit may not be obtained.

### SUMMARY OF INVENTION

It is, therefore, an object of the present invention to provide a panel driver of a liquid crystal display LCD device using a super twisted nematic STN mode (hereinafter, referred as a STN LCD device) in order to having an efficient structure of the STN LCD device for a large integration.

In accordance with an aspect of the present invention, there is provided a panel driver for driving a STN LCD device, including at least one first unit for receiving a plurality of source voltages and supplying a selected source voltage among a plurality of driving power lines; and at least one second unit connected to the plurality of driving power lines for delivering the selected source voltage to a line.

In accordance with an aspect of the present invention, there is provided a panel driver for driving a liquid crystal display LCD device using a super twisted nematic STN mode, including at least one first supplying unit for receiving a plurality of first source voltages and respectively supplying a first selected source voltage to one of a first and a second driving power line; at least one second supplying unit for receiving a plurality of second source voltages and respectively supplying a second selected source voltage to one of a third and a fourth driving power lines; at least one first driving unit for receiving the first selected source voltage and driving a segment line in response to first and second driving voltage control signals; and at least one second driving unit for receiving the second selected source voltage and driving a common line in response to third and fourth driving voltage control signals.

### BRIEF DESCRIPTION OF THE DRAWINGS

The above and other objects and features of the instant invention will become apparent from the following description of preferred embodiments taken in conjunction with the accompanying drawings, in which:

FIG. 1 is a schematic circuit diagram showing structure of a cell array in a conventional liquid crystal display LCD device using a super twisted nematic STN mode;

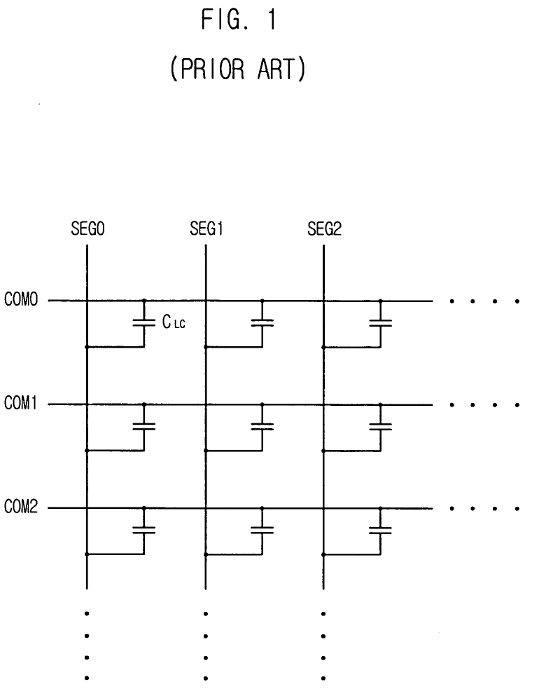

FIG. 2 is a schematic circuit diagram describing a panel driver of a conventional liquid crystal display LCD device using a super twisted nematic STN mode;

FIG. 3A is a layout depicting a plurality of conventional cells which are arranged in a matrix structure;

FIG. 3B is a waveform showing the pulses supplied at each line of the conventional liquid crystal display LCD device using a super twisted nematic STN mode;

FIG. 4 is a schematic circuit diagram showing a panel driver for a liquid crystal display LCD device using a super twisted nematic STN mode in accordance with a first embodiment of the present invention;

FIG. 5 is a schematic circuit diagram depicting a driving power supply block of a liquid crystal display LCD device using a super twisted nematic STN mode in accordance with a second embodiment of the present invention; and

FIG. 6 is a schematic circuit diagram showing a driving power supply block of a liquid crystal display LCD device using a super twisted nematic STN mode in accordance with a third embodiment of the present invention.

### DETAILED DESCRIPTION OF INVENTION

Hereinafter, a panel driver for driving a liquid crystal display LCD device using a super twisted nematic STN mode (hereinafter, referred as a STN LCD device) will be described in detail with reference to the accompanying drawings.

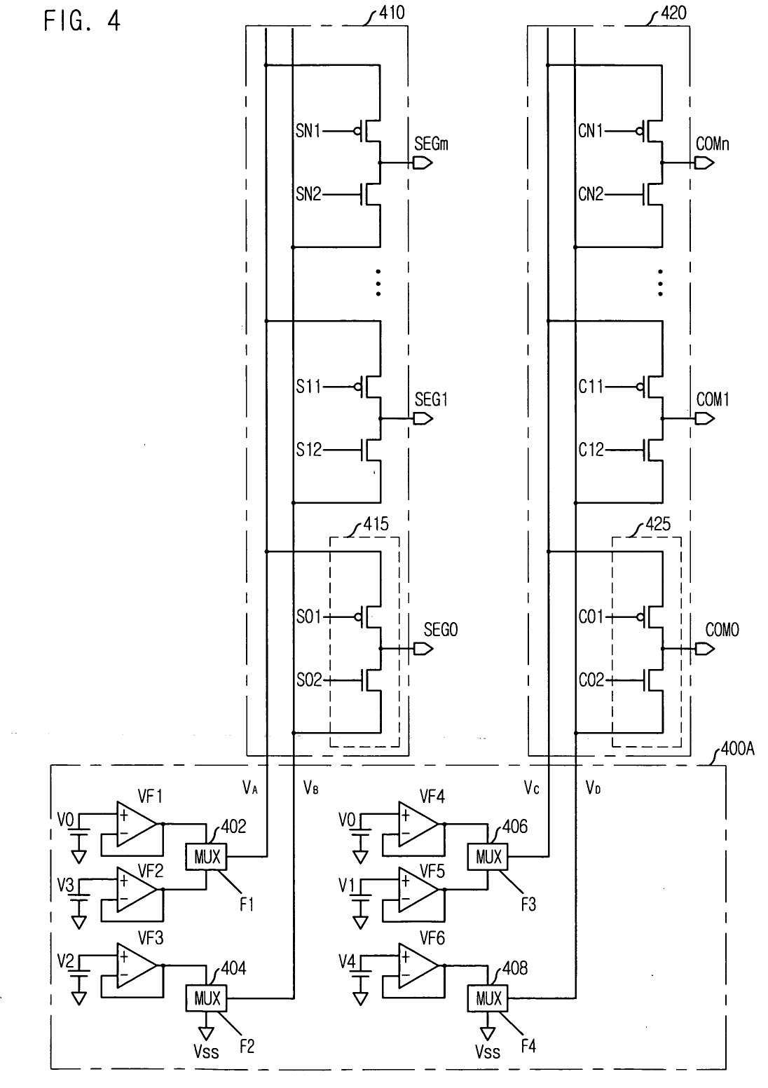

FIG. 4 is a schematic circuit diagram showing a panel driver for a STN LCD device in accordance with a first embodiment of the present invention.

As shown, the STN LCD device in accordance with the first embodiment of the present invention includes a driving power supply block 400A, a segment line driving block 410 and a common line driving block 420. The driving power supply block 400A receives a plurality of source voltages and outputs a first and a second selected source voltages to the segment line driving block 410 and the common line driving block 420. The segment line driving block 410 and the common line driving block 420 have a plurality of unit segment drivers and a plurality of unit common drivers, respectively. The segment and common unit drivers individually receive the first and the second selected source voltages and respectively deliver the first and the second selected source voltages to a segment line and a common line.

In detail, the driving power supply block 400A has first and second multiplexers 402 and 404 and first to third source followers VF1 to VF3 for supplying a source voltage to the segment line. The driving power supply block 400 further has third and fourth multiplexers 406 and 408 and fourth to sixth source followers VF4 to VF6 for supplying a source voltage to the common line.

Herein, the first to third source followers VF1 to VF3 respectively receive first, fourth and third source voltages V0, V3 and V2; and the fourth to sixth source followers VF4 to VF6 individually receive first, fifth and second source voltages V0, V4 and V1. The first and second source followers VF1 and VF2 output the first and fourth source voltages V0 and V3 to the first multiplexer 402. The second multiplexer 404 receives a sixth source voltage VSS and the third source voltage V2 which is output from the third source follower VF3. Likewise, the third multiplexer 406 receives the first source voltage V1 which is output from the fourth source follower VF4 and the second source voltage V1 which is output from the fifth source follower VF5, and the fourth multiplexer 408 receives the sixth source voltage VSS and the fifth source voltage V4 which is output from the sixth source follower VF6. Each multiplexer, e.g., 402 selects input source voltages in response to each source selecting signal, e.g., F1. Thus, the first to fourth multiplexers 402, 404, 406 and 408 can respectively output each corresponding source voltage to first to fourth driving power lines.

Herein, in one frame, each segment line and each common line need only two kinds of source voltage because the source voltage determines whether each line is selected or not. Thus, in every frame, for supplying different source voltage to the first to fourth driving power lines, the source selecting signal, e.g., F1 selects one of the source voltages input to each multiplexer, e.g. 402.

The segment line driving block 410 connected to the first and second driving power lines Va and Vb includes a plurality of unit segment drivers. The number of unit segment drivers corresponds with the number of segment lines. Herein, only first unit segment driver 415 is described because each unit segment driver has the same structure. The first unit segment driver 415 has a first PMOS transistor controlled by a first segment driving voltage control signal S01 for transmitting a first source voltage supplied at the first driving power line Va to the first segment line SEG0; and a first NMOS transistor controlled by the second segment driving voltage control signal S02 for transmitting a second source voltage supplied at the second driving power line Vb to the first segment line SEG0. Other unit segment drivers respectively are controlled by each different segment driving voltage control signal.

In addition, the common line driving block 420 connected to the third and fourth driving power lines Vc and Vd includes a plurality of unit common drivers. The number of unit common drivers corresponds with the number of common lines. Likewise for the segment line driving block 420, each unit common driver has same structure. The first unit common driver 425 has a second PMOS transistor controlled by a first common driving voltage control signal C01 for transmitting a third source voltage supplied at the third driving power line Vc to the first common line COM0; and a second NMOS transistor controlled by a second common driving voltage control signal C02 for transmitting a fourth source voltage supplied at the fourth driving power line Vc to the first common line SEG0. Other unit common drivers respectively are controlled by each different common driving voltage control signal.

Hereinafter, there is described operation of the panel driver used in the STN LCD device in accordance with above described structure.

In a frame, the first, second, fifth and sixth source voltages V0, V1, V4 and VSS can drive each common line. There are steps for driving the first common line COM0 by the first source voltage V0: first, the third multiplexer 402 of the driving power supply block 400A selects the first source voltage V0 output from the fourth source follower VF4 as the third source voltage which is supplied at the third driving power line Vc; second, if the first common driving voltage control signal C01 is at logical low, the first common line COM0 is supplied with the first source voltage V0. Herein, each source follower VF4 to VF6 has an unlimited input resistance; and its gain is 1. As a result, level of the output voltage is the same as that of the input voltage. Namely, when the third multiplexer 406 selects the output from the fourth source follower VF4, the third driving power line Vc is supplied with the first source voltage V0. At this time, if the first common driving control signal C01 is input at logical low, the first common line COM0 can be supplied with the first source voltage V0.

Otherwise, for supplying the first common line COM0 with the second source voltage V1, the fourth multiplexer 408 outputs the second source voltage V1 output from the sixth source follower VF6 to the fourth driving power line Vd and the second common driving control signal C02 is activated at logical high.

Likewise, other common lines COM1 to COMn can be controlled, i.e., supplied by two source voltages among four source voltages V0, V1, V4 and VSS. Herein, n is a positive integer and means the number of common lines.

As described above, in the frame, the first, third, fourth and sixth source voltages V0, V2, V3 and VSS can drive each segment line. There are steps for driving the first segment line SEG0 by the first source voltage V0: first, the first multiplexer 402 of the driving power supply block 400A selects the first source voltage V0 output from the first source follower VF1 as the first source voltage which is supplied at the first driving power line Va; second, if the first segment driving voltage control signal S01 is at a logic low level, the first segment line SEG0 is supplied with the first source voltage V0. Herein, each source follower VF1 to VF3 has an unlimited input resistance; and its gain is 1. As a result, the level of the output voltage is identical to that of the input voltage. Namely, when the first multiplexer 402 selects the output from the first source follower VF1, the first driving power line Va is supplied with the first source voltage V0. At this time, if the first segment driving control signal S01 is input at logical low, the first segment line SEG0 can be supplied with the first source voltage V0.

Otherwise, for supplying the first segment line SEG0 with the third source voltage V2, the second multiplexer 404 outputs the third source voltage V2 output from the third source follower VF3 to the second driving power line Vb and the second segment driving control signal S02 is activated in a logic high level.

Likewise, other segment lines SEG1 to SEGm can be controlled, i.e., supplied by two source voltages among four source voltages V0, V2, V3 and VSS. Herein, m is a positive integer and means the number of segment lines.

As a result, if a common line is selected, pixels coupled to the common line and segment line supplied with one source voltage are activated; and others coupled to the common line and segment line supplied with the other source voltage are inactivated. Thus, all of common lines are sequentially selected in one frame, and all of segment lines are supplied with two different source voltages every selected common line.

In addition, the first to fourth multiplexers 402, 404, 406 and 408 included in the driving power supply block 400A are respectively controlled by each power selecting signal, e.g., F1, F2, F3 and F4. Namely, each power selecting signal F1, F2, F3 and F4 can select source voltage supplied to the first to fourth driving power lines Va, Vb, Vc and Vd by controlling the first to the fourth multiplexers 402, 404, 406 and 408.

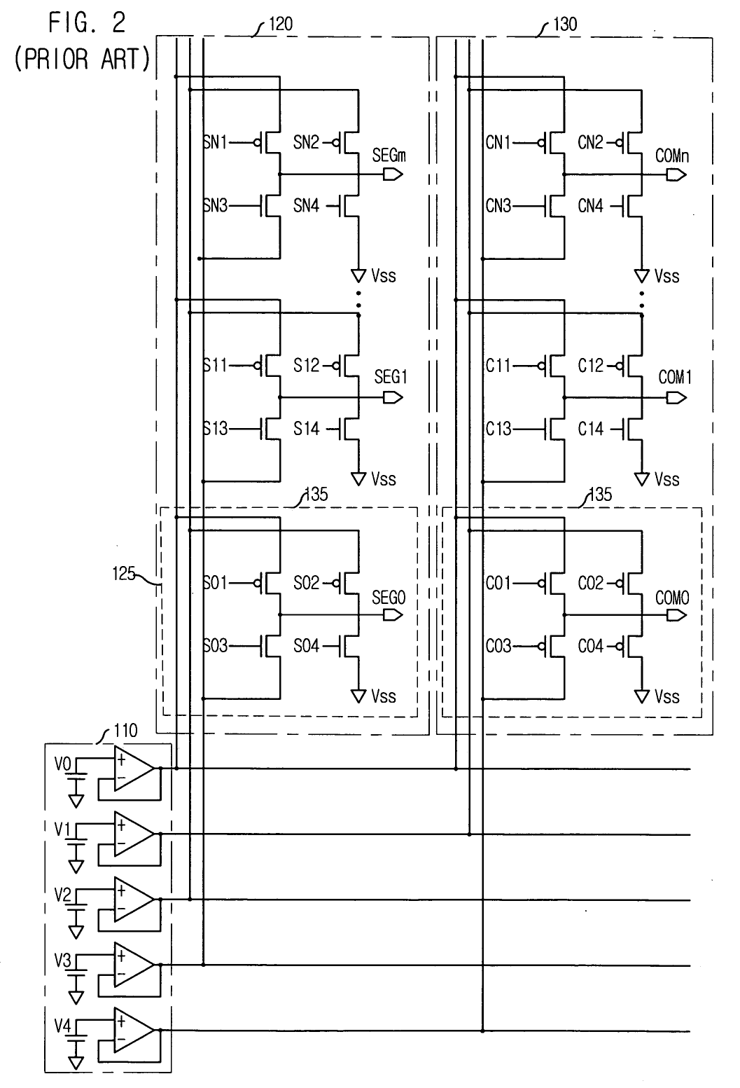

The panel driver of the STN LCD driver in accordance with the first embodiment of the present invention reduces the number of driving power lines by supplying each line with one of two source voltages; and also reduces area of the panel driver by decreasing the number of transistors included in the segment and common line driving blocks. In detail, referring to FIGS. 2 and 4, the number of driving power lines decreases 6 to 4; the number of MOS transistors is 4 to 2. As a result, chip size of the panel driver in accordance with the first embodiment of the present invention can decrease about 50% as the panel driver has more lines.

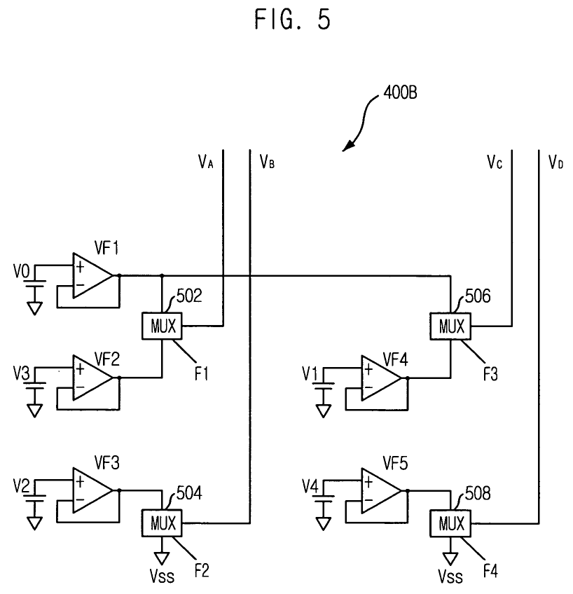

FIG. 5 is a schematic circuit diagram depicting a driving power supply block 400B of a STN LCD device in accordance with a second embodiment of the present invention.

As shown, the driving power supply block 400B in accordance with a second embodiment of the present invention includes a plurality of source voltages V0, V1, V2, V3, V4 and VSS; a plurality of source followers VF1, VF2, VF3, VF4 and VF5 for individually receiving each input source voltage, e.g., V0, V3, V2, V4 and V1, orderly; and first to fourth multiplexers 502, 504, 506 and 508 for respectively selecting an one of two input source voltages. The first multiplexer 502 receives the first source voltage V0 and the fourth source voltage V3, i.e., the output voltages from the first and second source followers VF1 and VF2. The second multiplexer 504 receives the sixth source voltage VSS and the third source voltage V2 output from the third source follower VF3. The third multiplexer 506 receives the first source voltage V0 and the second source voltage V1, i.e., the output voltages from the first and fourth source followers VF1 and VF4. Last, the fourth multiplexer 508 receives the sixth source voltage VSS and the fifth source voltage V4 output from the fifth source follower VF5.

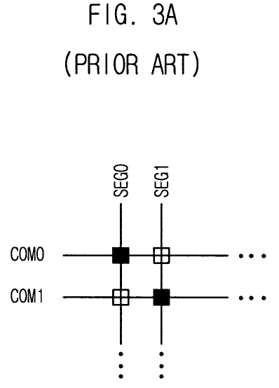

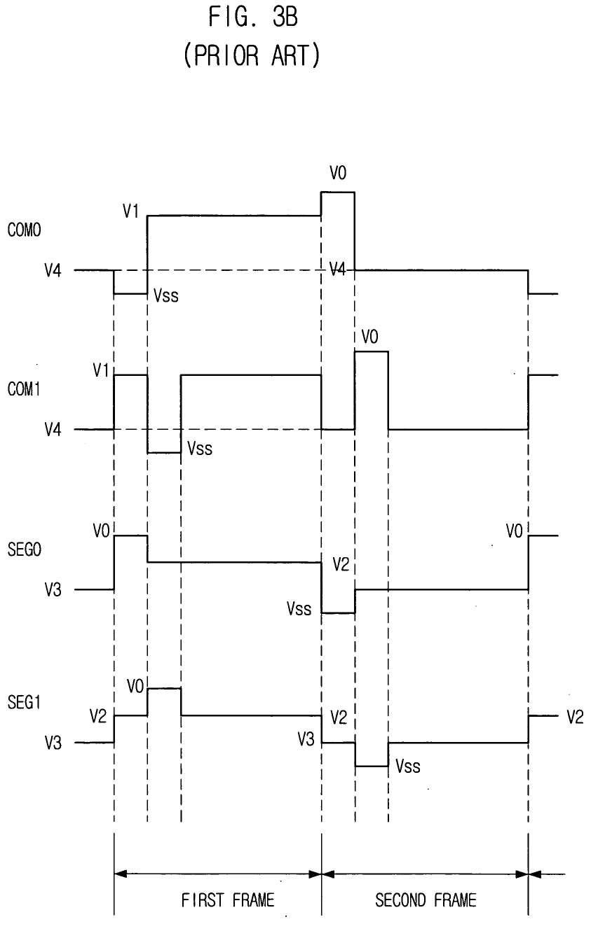

The driving power supply block 400B in accordance with the second embodiment of the present invention can reduce one source follower by inputting the first source voltage V0 to the first and third multiplexers 502 and 506. Referring to FIG. 3, the first source voltage V0 is not simultaneously supplied to both the segment line and the common line, e.g., SEG0 and COM0. Even If the first source voltage V0 is simultaneously supplied to the segment line and the common line, e.g., SEG0 and COM0, some operation errors are prevented by using fifth to eighth power selecting controls PS5 to PS8 which control multiplexers. In this case, except that the first and third multiplexers 502 and 506 share the first source voltage V0, i.e., the output voltage from the first source follower VF1, operation of the driving power supply block 400B is the same as that of the driving power supply block 400A shown in the FIG. 4. Therefore, the driving power supply block 400B in accordance with the second embodiment of the present invention has the advantage of reducing the number of source followers included in the driving power supply block.

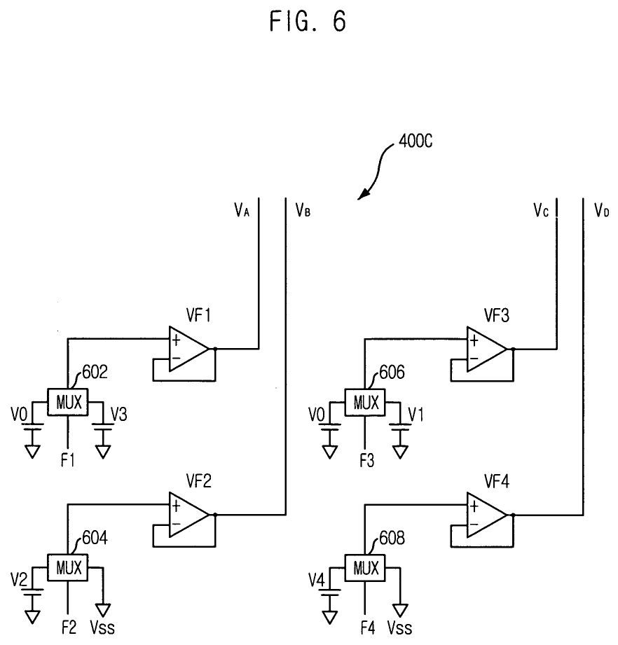

FIG. 6 is a schematic circuit diagram showing a driving power supply block 400C of a STN LCD device in accordance with a third embodiment of the present invention.

As shown, the driving power supply block 400C of the STN LCD device in accordance with the third embodiment of the present invention includes a plurality of source voltages V0, V1, V2, V3, V4 and VSS; first to fourth multiplexers 502, 504, 506 and 508 for respectively selecting one of two input source voltages; and a plurality of source followers VF1, VF2, VF3 and VF4 for individually transmitting each source voltage output from each multiplexer. The first multiplexer 602 outputs an one of the first and fourth source voltages V0 and V3 to the first source follower VF1. Likewise, the second multiplexer 604 outputs one of the third and sixth source voltages V2 and VSS to the second source follower VF2. The third multiplexer 606 outputs one of the first and second source voltages V0 and V1 to the third source follower VF3. Last, the fourth multiplexer 608 outputs one of the fifth and sixth source voltages V4 and VSS to the fourth source follower VF4.

The driving power supply block 400C in accordance with the third embodiment has some differences from blocks 400A and 400B in accordance with the first and second embodiments. Namely, the plurality of multiplexers directly receives a plurality of source voltages V0 to VSS. Then, the plurality of multiplexers output each corresponding source voltage to each source follower respectively. As a result, referring to FIG. 6, there are four source followers VF1, VF2, VF3 and VF4; thus, the number of source followers included in the driving power supply block 400C is reduced by 2 in comparison with that block 400A in accordance with the first embodiment.

The above described panel drivers in accordance with the first to third embodiment use the first to sixth source voltages V0 to VSS. However, if the number of source voltages is changed in according to the capability of the STN LCD device, the above described panel drivers of the present invention can be also changed.

In the panel driver of the STN LCD device in accordance with the first to third embodiments of the present invention, circuit size can be less than half that of the panel driver in accordance with the prior art. As a result, the STN LCD device having the panel driver of the STN LCD device in accordance with the first to third embodiments of the present invention can be decreased and reduce cost of manufacture.

While the present invention has been described with respect to the particular embodiments, it will be apparent to 5 those skilled in the art that various changes and modifications may be made without departing from the spirit and scope of the invention as defined in the following claims.

What is claimed is:

1. A panel driver for driving a liquid crystal display device using a super twisted nematic STN mode, comprising:
at least one first means for receiving a plurality of source voltages and supplying a selected source voltage among a plurality of driving power lines; and
at least one second means connected to the plurality of driving power lines for delivering the selected source voltage to a line.

2. The panel driver as recited in claim 1, further comprising:
a first driving power line; and
a second driving power line,
wherein said first means outputs the selected source voltage to one of a first and a second driving power lines.

3. The panel driver as recited in claim 2, wherein the second means includes
a first transistor controlled by the first driving voltage control signal for transmitting the selected source voltage supplied at the first driving power line to the line; and
a second transistor controlled by the second driving voltage control signal for transmitting the selected source voltage supplied at the second driving power line to the line.

4. The panel driver as recited in claim 3, wherein the first means includes
a plurality of voltage following means for delivering the plurality of source voltages; and
a multiplexing means for receiving the plurality of source voltages from the plurality of voltage following means and outputting the selected source voltage to one of the first and the second driving power lines in response to a power selecting signal.

5. The panel driver as recited in claim 3, wherein the first means includes
a multiplexing means for receiving the plurality of source voltages and outputting the selected source voltage in response to a power selecting signal; and
a plurality of voltage following means for delivering the selected source voltage to one of the first and the second driving power lines.

6. A panel driver for driving a liquid crystal display device using a super twisted nematic STN mode, comprising:
at least one first supplying means for receiving a plurality of first source voltages and respectively supplying a first selected source voltage to one of a first and a second driving power lines;
at least one second supplying means for receiving a plurality of second source voltages and respectively supplying a second selected source voltage to one of a third and a fourth driving power lines;
at least one first driving means for receiving the first selected source voltage and driving a segment line in response to first and second driving voltage control signals; and
at least one second driving means for receiving the second selected source voltage and driving a common line in response to third and fourth driving voltage control signals.

7. The panel driver as recited in claim 6, wherein the first supplying means includes
a plurality of voltage following means for delivering the plurality of first source voltages; and
a multiplexing means for receiving the plurality of first source voltages from the plurality of voltage following means and outputting the first selected source voltage to one of the first and the second driving power lines in response to a first power selecting signal.

8. The panel driver as recited in claim 7, wherein the second supplying includes
a plurality of voltage following means for delivering the plurality of second source voltages; and
a multiplexing means for receiving the plurality of second source voltages from the plurality of voltage following means and outputting the second selected source voltage to one of the third and the fourth driving power lines in response to a second power selecting signal.

9. The panel driver as recited in claim 6, wherein the first supplying includes
a multiplexing means for receiving the plurality of first source voltages and outputting the first selected source voltage in response to a first power selecting signal; and
a plurality of voltage following means for delivering the first selected source voltage to one of the first and the second driving power lines.

10. The panel driver as recited in claim 9, wherein the second supplying means includes
a multiplexing means for receiving the plurality of second source voltages and outputting the second selected source voltage in response to a second power selecting signal; and
a plurality of voltage following means for delivering the second selected source voltage to one of the third and the fourth driving power lines.

11. The panel driver as recited in claim 6, wherein the first driving means includes
a first line driver controlled by the first driving voltage control signal for transmitting the first selected source voltage supplied at the first driving power line to the segment line; and
a second line driver controlled by the second driving voltage control signal for transmitting the first selected source voltage supplied at the second driving power line to the segment line.

12. The panel driver as recited in claim 11, wherein the first line driver includes a first MOS transistor for delivering the first selected source voltage supplied at the first driving power line to the segment line, a gate of the first MOS transistor being connected to the first driving voltage control signal.

13. The panel driver as recited in claim 12, wherein the second line driver includes a second MOS transistor for delivering the first selected source voltage supplied at the second driving power line to the segment line, a gate of the second MOS transistor being connected to the second driving voltage control signal.

14. The panel driver as recited in claim 11, wherein the second driving means includes
a third line driver controlled by the third driving voltage control signal for receiving the second selected source voltage supplied to the third driving power line; and
a fourth line driver controlled by the fourth driving voltage control signal for receiving the second selected source voltage supplied to the fourth driving power line.

15. The panel driver as recited in claim 14, wherein the third line driver includes a third MOS transistor for delivering the second selected source voltage supplied at the third driving power line to the common line, a gate of the third MOS transistor being connected to the third driving voltage control signal.

16. The panel driver as recited in claim 15, wherein the fourth line driver includes a fourth MOS transistor for delivering the second selected source voltage supplied at the fourth driving power line to the common line, a gate of the fourth MOS transistor being connected to the fourth driving voltage control signal.
